(19) United States
(12) Patent Application Publication
(10) Pub. No.: US 2026/0097760 A1
(43) Pub. Date: Apr. 9, 2026

(54) VEHICULAR PARKING ASSIST SYSTEM

(71) Applicant: Magna Electronics Inc., Auburn Hills, MI (US)

(72) Inventors: Jyothi P. Gali, Rochester Hills, MI (US); Harold E. Joseph, Brampton (CA); Prasanna Ananthakrishnan, Tamilnadu (IN)

(21) Appl. No.: 19/344,691

(22) Filed: Sep. 30, 2025

Related U.S. Application Data
(60) Provisional application No. 63/702,706, filed on Oct. 3, 2024.

(51) Int. Cl. B60W 30/09; B60W 30/06; B60W 30/095; G01S 15/931; G06V 10/44; G06V 20/56

(52) U.S. Cl. CPC B60W 30/09; B60W 30/06; B60W 30/0956; G01S 15/931; G06V 10/44; G06V 20/56; B60W 2420/403; B60W 2420/54; B60W 2554/4041; G01S 2015/937

(57) ABSTRACT

A vehicular parking assist system includes an ultrasonic sensor disposed at a vehicle that captures sensor data and a sideward-viewing camera disposed at the vehicle that captures image data. During a parking maneuver, when image data captured by the camera is compromised, and based on processing of sensor data captured by the ultrasonic sensor, and without processing image data captured by the camera, the system detects an edge of an object and determines presence of an available parking space. The system at least partially controls operation of the vehicle as the vehicle is moved relative to the object and into the parking space. As the vehicle is moved into the parking space, and based on processing of sensor data captured by the ultrasonic sensor, the system tracks position of the detected edge relative to the vehicle and adjusts control of the vehicle.

### CROSS REFERENCE TO RELATED APPLICATION

The present application claims the filing benefits of U.S. provisional application Ser. No. 63/702,706, filed Oct. 3, 2024, which is hereby incorporated herein by reference in its entirety.

### FIELD OF THE INVENTION

The present invention relates generally to a vehicle sensing system for a vehicle and, more particularly, to a vehicle sensing system that utilizes one or more exterior sensors at a vehicle.

### BACKGROUND OF THE INVENTION

Use of sensors in vehicle sensing systems is common and known. Such sensors are integrated at the vehicle and may sense areas rearward of the vehicle to assist the driver in reversing the vehicle.

### SUMMARY OF THE INVENTION

A driving assistance system or vision system or imaging system for a vehicle includes one or more ultrasonic sensors disposed at a vehicle that sense exterior of the vehicle and capture sensor data. An electronic control unit (ECU) includes electronic circuitry and associated software. The ECU includes a processor for processing sensor data transferred to the ECU. Based on processing at the ECU of sensor data captured by the ultrasonic sensors, the system determines a boundary of an available parking space near the vehicle. For example, the system determines the boundary of the available parking space near a scanning process of a parking maneuver. During the parking maneuver of the vehicle, the system at least partially controls operation of the vehicle as the vehicle is moved into the boundary of the available parking space. For example, the system controls a steering system, a propulsion system and/or a braking system of the vehicle as the vehicle is moved into the parking space. During the parking maneuver of the vehicle, and as the vehicle is moved into the boundary of the available parking space, and based on processing at the ECU of sensor data captured by the ultrasonic sensor, the system adjusts the boundary of the available parking space. The system provides an automated parking system that detects and tracks available parking spaces without the use of image data.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vehicular driver assist system that utilizes ultrasonic sensors;

FIG. 2 is a plan view of the vehicle showing example positions of ultrasonic sensors at the vehicle;

FIG. 3A is an environmental view of a perpendicular parking space;

FIG. 3B is an environmental view of a parallel parking space;

FIG. 4A is a top down view of the vehicle as the system determines a boundary of a perpendicular parking space near the vehicle;

FIG. 4B is a top down view of the vehicle during a nose-in parking maneuver where the system controls operation of the vehicle as the vehicle moves forward into the perpendicular parking space;

FIG. 4C is a top down view of the vehicle during a rear-in parking maneuver where the system controls operation of the vehicle as the vehicle moves rearward into the perpendicular parking space;

FIG. 5A is a top down view of the vehicle as the system determines a boundary of a parallel parking space near the vehicle;

FIG. 5B is a top down view of the vehicle during a parallel parking maneuver where the system controls operation of the vehicle as the vehicle moves into the parallel parking space;

FIG. 6 is a flow diagram representing the flow of ultrasonic sensor data and vehicle kinematic data during determination of the boundary of the parking space; and

FIG. 7 is a schematic diagram of the system.

### DESCRIPTION OF THE PREFERRED EMBODIMENTS

A vehicle vision system and/or driver or driving assist system and/or object detection system and/or alert system operates to capture images and/or sensor data exterior of the vehicle and may process the captured image data and/or sensor data to display images and/or to detect objects at or near the vehicle and in the predicted path of the vehicle, such as to assist a driver of the vehicle in maneuvering the vehicle in a rearward direction during a parking maneuver. The vision system includes a data processor for processing captured sensor data and an image processor or image processing system that is operable to receive image data from one or more cameras and provide an output to a display device for displaying images representative of the captured image data. Optionally, the vision system may provide display, such as a rearview display or a top down or bird's eye or surround view display or the like.

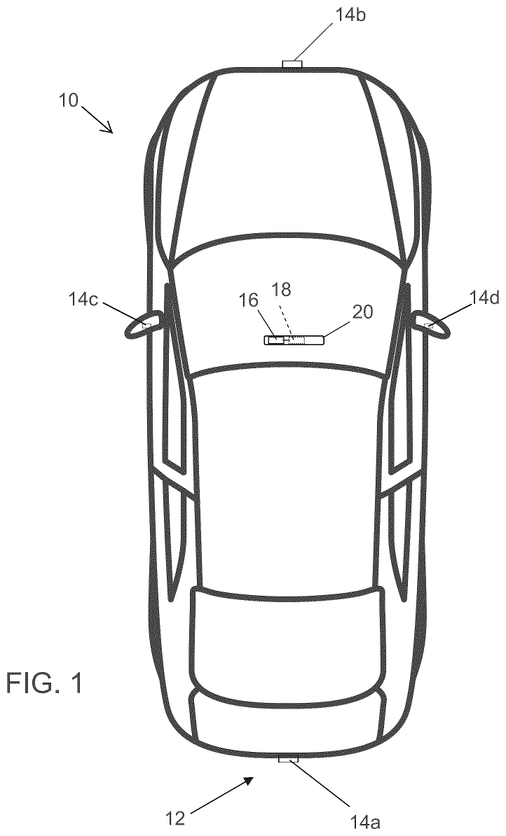

Referring now to the drawings and the illustrative embodiments depicted therein, a vehicle 10 includes an imaging system or vision system 12 that includes at least one exterior-viewing imaging sensor or camera, such as a rear backup camera or rearward-viewing imaging sensor or camera 14a (and the system may optionally include multiple exterior viewing imaging sensors or cameras, such as a forward-viewing camera 14b at the front (or at the windshield) of the vehicle, and a sideward/rearward-viewing camera 14c, 14d at respective sides of the vehicle), which captures images exterior of the vehicle, with the camera having a lens for focusing images at or onto an imaging array or imaging plane or imager of the camera (FIG. 1). Optionally, a forward-viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

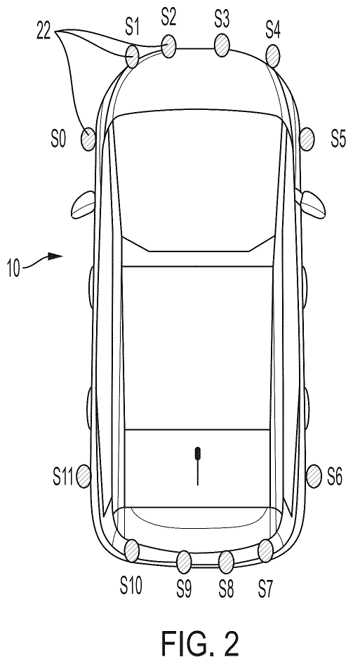

As shown in FIG. 2, the vehicle 10 further includes a plurality of ultrasonic sensors 22 disposed at the vehicle 10 and configured to sense respective regions exterior of the vehicle 10. The vehicle 10 may include any suitable number of ultrasonic sensors 22, such as 12 or more ultrasonic sensors, or fewer than 12 ultrasonic sensors. In the illustrated example, the vehicle 10 includes ultrasonic sensors 22 disposed at a front portion of the vehicle, such as at or near a front bumper or grille or front fascia of the vehicle, and configured to sense a region exterior of the vehicle and at least forward of the vehicle. Respective ultrasonic sensors 22 disposed at side portions of the vehicle 10, such as at or near the wheel wells or wheel arches of the vehicle 10, may be configured to sense regions exterior of the vehicle and at least along the respective sides of the vehicle. Ultrasonic sensors 22 disposed at a rear portion of the vehicle 10, such as at or near a rear bumper of the vehicle 10, may be configured to sense a region exterior of the vehicle and at least rearward of the vehicle. Each ultrasonic sensor 22 may have a field of view of about 60 degrees or more and a sensing range of about 3.5 meters or more. The field of view of the sensors 22 may allow the system 12 to detect objects placed in a tight corner space (e.g., vehicles parked deep between two other vehicles).

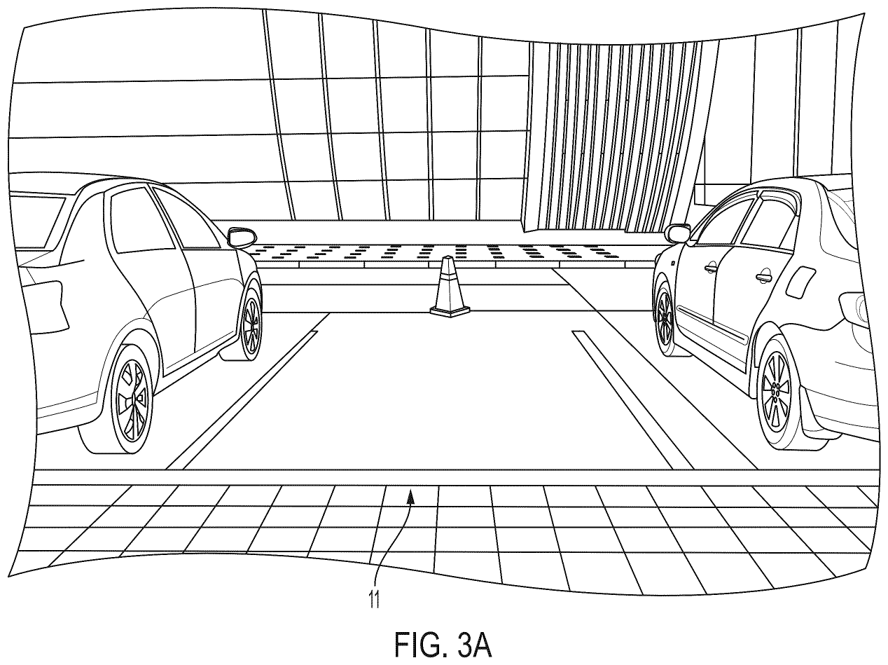

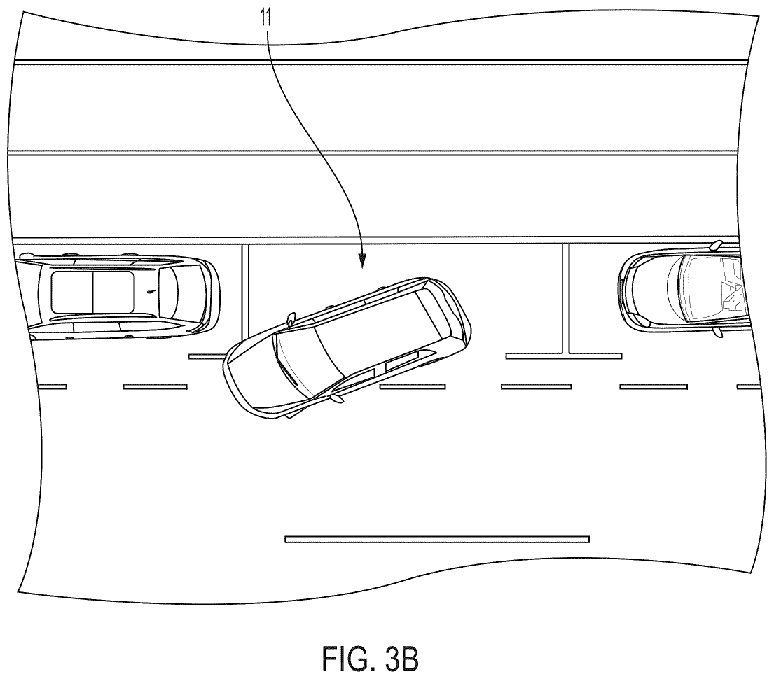

As discussed further below, sensor data captured by the ultrasonic sensors 22 disposed at the vehicle 10 may be processed at the ECU during a parking maneuver of the vehicle 10. Based on processing of the captured sensor data, the vision system 12 determines presence of a parking space 11 suitable to receive the vehicle and, as the vehicle is guided into the parking space 11, the system updates detected bounds of the parking space 11 and may detect presence of objects in the path of the vehicle 10. The system may be configured to determine presence of perpendicular parking spaces (FIG. 3A) and parallel parking spaces (FIG. 3B), as well as diagonal or angled parking spaces or any parking space having suitable space and dimensions for receiving the vehicle (e.g., a driveway or a space between vehicles in a field or lot).

Parking in tight spaces may be challenging for a driver. While both cameras and ultrasonic sensors may be used to detect parking slots for automated parking systems, parking lines may not always be present or visible, such as due to fading over time. Further, image data captured by the cameras may become compromised or unreliable, such as due to occlusions blocking the view of the camera (e.g., dirt, moisture, or debris at the camera lens or presence of an object close to the vehicle), camera failure, and the like. Thus, the system provides automated parking using sensor data from one or more ultrasonic sensors. During a scanning phase, a parking gap is identified. For example, the parking gap may be identified based on a threshold amount of space next to an object or vehicle or may be identified as being between two objects or vehicles. Once the parking slot is identified, the selected slot may be tracked and adjusted accordingly as the vehicle parks inside the slot. The system may be operable to provide parallel and perpendicular parking slot detection and detect objects in the path of the vehicle while parking in the slot.

That is, the system presents a standalone application of using ultrasonic sensors to detect parking slots between two vehicles and track slots using ultrasonic sensors and vehicle ego motion. Slots may be categorized into parallel and perpendicular and angled slots and the system may provide rear-in and nose-in parking. Based on the parking mode, the system tracks the slots using specific ultrasonic sensors from the parking mode configuration. The updated vehicle slot coordinates may be sent to a vehicle control module for steering the vehicle and parking the vehicle in the slot. The system may also provide a vehicle collision avoidance feature, such as if there is a sudden appearance of an object in the vehicle trajectory into the parking slot as detected by the ultrasonic sensors. The system may detect the parking slot, at least partially control operation of the vehicle, and perform object detection as the vehicle is moved into the parking slot based on processing of the sensor data captured by the ultrasonic sensors and without processing image data captured by one or more of the cameras at the vehicle (e.g., the rearward-viewing camera, one or more of the sideward-viewing cameras, the forward-viewing camera, and the like).

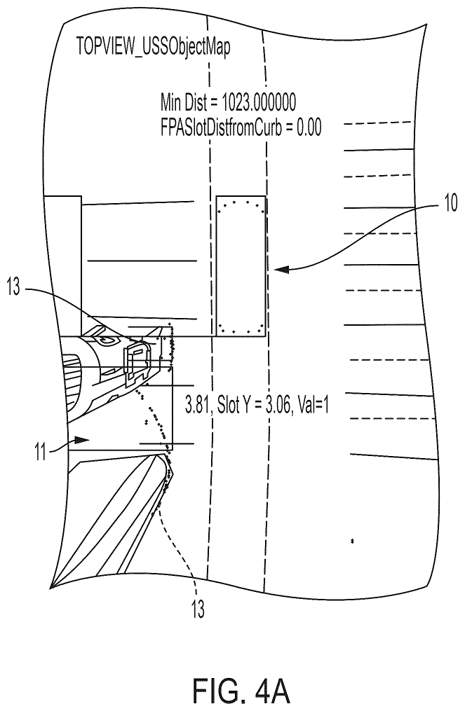

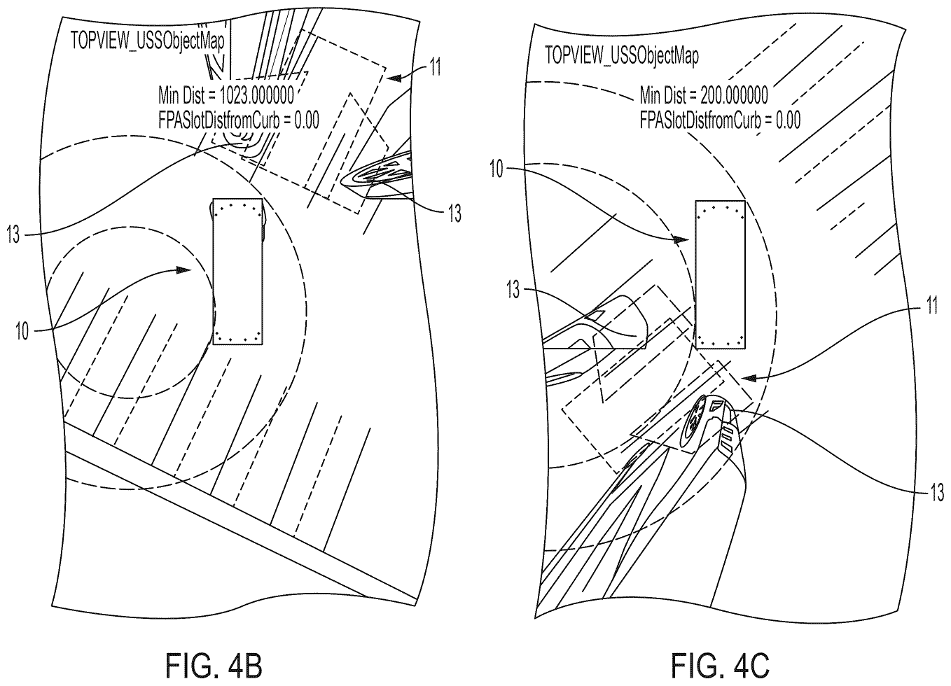

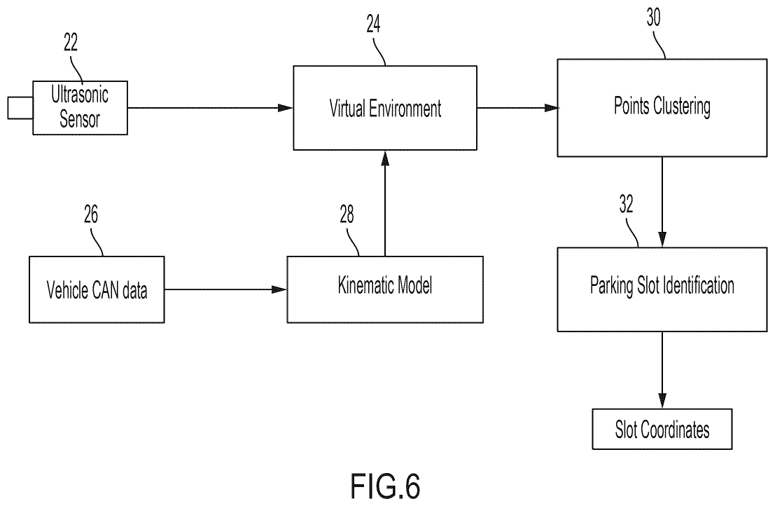

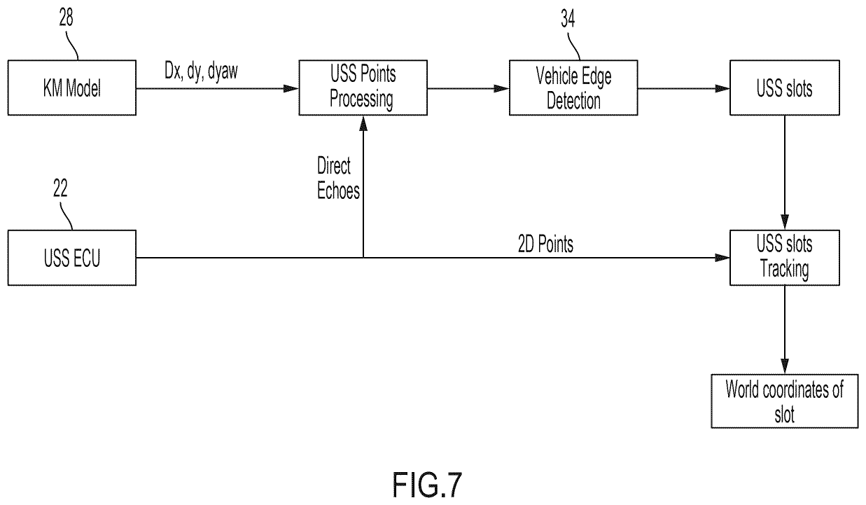

Referring to FIGS. 4A-7, during an automated parking maneuver, the ultrasonic sensors 22 at the vehicle 10 capture sensor data representative of the environment surrounding the vehicle 10. Each ultrasonic sensor 22 may generate sensor data representative of an echo distance (e.g., a distance to a detected object in centimeters) and an echo timestamp (e.g., a time during the parking maneuver at which the object is detected in milliseconds) and this sensor data may be used to generate or populate a virtual environment 24 representative of the environment surrounding the vehicle 10. Vehicle kinematic data 26, such as data received by the system over the CAN bus (e.g., vehicle speed in kilometers per hour or miles per hour, vehicle wheel angles in degrees, vehicle longitudinal movement (Dₓ), vehicle lateral movement (D_{y}), vehicle yaw movement (D_{yaw}) and the like), may be used to generate a kinematic model 28 of the vehicle 10. The virtual environment 24 may be generated or populated based on or including the kinematic model 28 of the vehicle 10. Optionally, the virtual environment 24 may be generated based on image data captured by cameras at the vehicle 10, such as image data captured by a camera monitoring system (CMS) of the vehicle 10.

Based on the ultrasonic sensor data and the vehicle kinematic data 26, the system 12 performs a parking space identification process 32 to determine presence of one or more parking spaces 11 near the vehicle 10. For example, the system 12 may perform the parking space identification process 32 based on performing a points clustering step 30 using the ultrasonic sensor data. The system may thus receive coordinates (e.g., world coordinates) of the parking space 11 relative to the vehicle 10.

FIG. 4A shows an overhead or bird's eye view of the vehicle 10 during detection of a perpendicular or horizontal parking space 11. Perpendicular or horizontal parking spaces are arranged so that vehicles are side to side, parallel to one another and perpendicular to a curb or wall. Perpendicular or angled parking may fit more vehicles per length of road than parallel parking when a wider space is available and therefore may be commonly used in parking lots and parking structures.

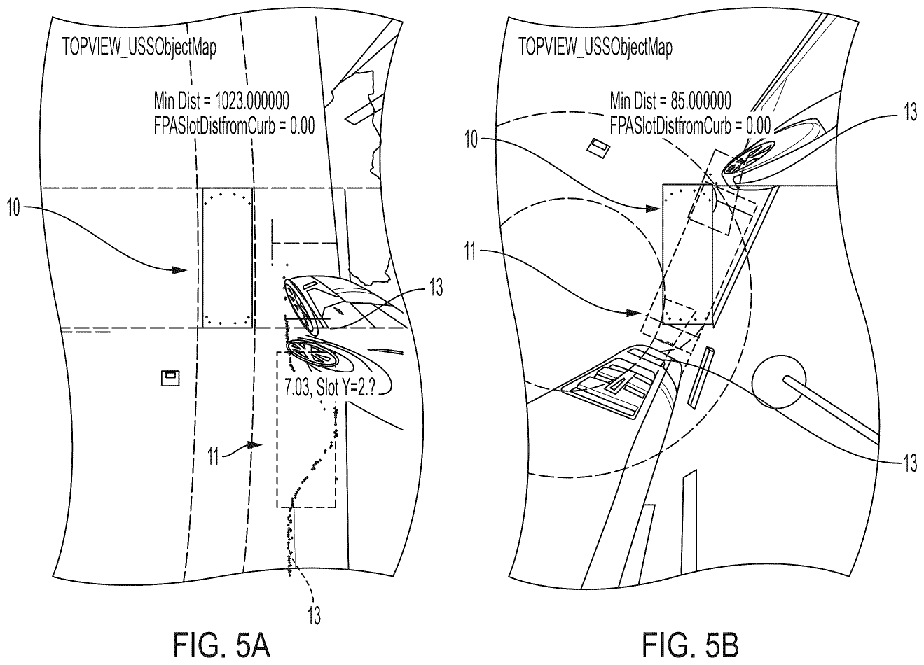

FIG. 5A shows an overhead or bird's eye view of the vehicle 10 during detection of a parallel parking space 11. Parallel parking spaces are arranged in a straight line, with the front bumper of the vehicle 10 facing the rear bumper of another vehicle 13. This may be done parallel to a curb, if present. Parallel parking is a common mode of streetside parking for vehicles and may be used in parking lots and parking structures.

During a vehicle edge detection process 34, the ultrasonic sensor data may be processed to determine presence of one or more other vehicles 13 and/or objects near the parking space 11. Further, the ultrasonic sensor data is processed to determine the presence of the parking space 11 between the other vehicles 13 and/or objects. For example, the system 12 may determine presence of the other vehicles 13, curbs, parking blocks, walls or barriers, trees or shrubs, or other objects that may at least in part define or identify the boundary or position of the parking space 11. Because the other vehicles 13 and/or objects may at least partially block the ultrasonic sensors 22 from detecting or sensing the full area of the parking space 11, the parking space 11 may be determined based on sensing at least a threshold level of free space next to and/or between the other vehicles 13 and/or objects. As shown in FIGS. 4A and 5A, this may include a cluster of points at least a threshold distance from the detected edges of the other vehicles 13 and/or a cluster of points representative of a curb between the other vehicles 13. Thus, as the vehicle 10 is maneuvered into the parking space 11 and the ultrasonic sensors have a less obstructed view of the parking space 11, the ultrasonic sensor data is processed to track the bounds of the parking space 11 (e.g., the curb and/or other vehicles 13) and/or presence of objects in the path of the vehicle.

That is, when the parking space 11 is located between two other vehicles 13 and/or objects, a detected edge of one of the other vehicles 13 and/or object may at least partially define or establish a first portion of the boundary of the parking space 11 and a detected edge of the other one of the other vehicles 13 and/or object may at least partially define or establish a second portion of the boundary of the parking space 11. The system 12 may determine presence of the parking space 11 based on the ultrasonic sensor data indicating at least a threshold distance between the detected edges of the two other vehicles 13 and/or objects (e.g., the threshold distance may be greater than or equal to a width of the vehicle 10 for a perpendicular or angled parking space and greater than or equal to a length of the vehicle 10 for a parallel parking space). When the parking space 11 is located next to one other vehicle 13 or object (e.g., with an area on the opposite side of the parking space 11 devoid of other vehicles or objects), the detected edge of the other vehicle 13 or object may at least partially define or establish a first portion of the boundary of the parking space 11. The system 12 may determine presence of the parking space 11 based on the ultrasonic sensor data indicating at least the threshold distance of space next to the detected edge of the other vehicle 13 or object. Optionally, the threshold distance may be based at least in part on a sensing range of the ultrasonic sensors 22 (e.g., about 3.5 meters or greater), such that a cluster of points at or near the threshold distance from the vehicle may indicate free space within the sensing range of the ultrasonic sensors 22. The system 12 may thus use the detected edges of one or more other vehicles 13 and/or objects as reference points for determining presence and relative position of the parking space 11 to the vehicle 10, such as due to an inability to determine the parking space 11 using captured image data (e.g., due to unidentifiable or non-existent parking lines, due to an occluded camera lens, and the like).

During tracking of the parking space 11 (i.e., during monitoring of the ultrasonic sensor data to determine the free space between other vehicles and/or objects), and as the vehicle 10 maneuvers into or toward the parking space 11 during the parking maneuver, sensor data captured by the ultrasonic sensors 22 may be processed to adjust coordinates of the parking space 11 relative to the vehicle 10. For example, as the vehicle 10 moves further into or toward the parking space 11, a greater portion of the other vehicle 13 and/or object may be detectable by the ultrasonic sensors 22 and the detected edges and thus determined boundaries of the parking space 11 may be updated. The boundary of the parking space 11 may be determined based on at least a threshold level of clearance between the detected object and the vehicle 10 (e.g., such that the driver and/or occupants may be able to at least partially open the doors of the vehicle 10 when the vehicle is parked).

Different combinations of the ultrasonic sensors 22 may be used based on the type of parking maneuver. For example, when parking in a perpendicular or angled parking spot, the vehicle 10 may perform a nose-in parking maneuver (FIG. 4B), where the front portion of the vehicle leads as the vehicle 10 is maneuvered into the parking space 11, or a rear-in parking maneuver (FIG. 4C), where the rear portion of the vehicle leads as the vehicle 10 is maneuvered into the parking space 11. During the nose-in parking maneuver, two-dimensional (2D) sensor data from all ultrasonic sensors 22 at the vehicle and echoes from a front driver-side sensor and front passenger-side sensor may be used to adjust the coordinates of the parking space 11 relative to the vehicle 10. During the rear-in parking maneuver, 2D sensor data from all ultrasonic sensors 22 at the vehicle and echoes from a rear driver-side sensor and a rear passenger-side sensor may be used to adjust the coordinates of the parking space 11 relative to the vehicle 10.

When parking in a parallel parking spot, the rear portion of the vehicle 10 may lead as the vehicle is maneuvered into the parking spot 11 (FIG. 5B). During the parallel parking maneuver, 2D sensor data from all ultrasonic sensors 22 at the vehicle and echoes from the rear driver-side sensor and the rear passenger-side sensor may be used to adjust the coordinates of the parking space 11 relative to the vehicle 10. Sensor data from the sideward sensing sensors may be killed or not included once the vehicle 10 enters the parking spot 11.

Thus, when an automated parking maneuver is initiated, such as based on a user input selecting the automated parking maneuver and with a gear selector of the vehicle in a parking gear (e.g., when the gear selector of the vehicle is in reverse and the parking space is at least partially rearward of the vehicle, or when the gear selector of the vehicle is in drive and the parking space is at least partially forward of the vehicle, or when the gear selector of the vehicle is in neutral, or when the gear selector of the vehicle is in park) and/or moving at or below a threshold forward or reverse speed and with the vehicle near a potential parking space, the system 12 may process ultrasonic sensor data to scan for potential parking spaces near the vehicle 10. In some examples, the system 12 may initiate the automated parking maneuver based on determination that the vehicle 10 is located in a parking lot (e.g., based on a signal from a global positioning system (GPS) of the vehicle) and based on determination that the vehicle 10 is travelling at a speed less than a threshold speed. Optionally, the user input may indicate a desired type of parking maneuver (e.g., a perpendicular or angled nose-in parking maneuver or a parallel parking maneuver). During the scanning process, the system 12 may only process sensor data captured by ultrasonic sensors 22 at the respective corner regions of the vehicle 10 (e.g., the front driver-side ultrasonic sensor, the rear driver-side ultrasonic sensor, the front passenger-side ultrasonic sensor and the rear passenger-side ultrasonic sensor). Based on detecting a parking space 11 suitable to receive the vehicle 10, the vehicle 10 may be maneuvered toward and/or into the parking space 11. During movement of the vehicle 10, the system 12 may update or adjust coordinates of the parking space 11 based on the sensor data captured by the ultrasonic sensors 22. For example, the system 12 may track coordinates of the boundaries or edges of the parking space 11, which may be defined by detected vehicles 13 and/or objects adjacent the space 11 and/or a threshold distance or buffer distance from the detected vehicle 13 or object. Further, the system 12 may detect objects within the path of the vehicle 10 based on the captured sensor data.

The system 12 may provide an automated parking system for the vehicle 10 that operates based on ultrasonic sensor data and that does not process image data or does not rely on captured image data during the parking maneuver. Ultrasonic sensors may be light weight and cost effective compared to, for example, camera-based solutions. Image data alone may not be reliable due to, for example, fading of parking lines over time.

Parking based on the sensing of ultrasonic sensors may be safe as the system may detect objects in the path of the vehicle. Optionally, the vehicle may include one or more additional sensors, such as a radar sensor, lidar sensor, and the like.

For autonomous vehicles suitable for deployment with the system, an occupant of the vehicle may, under particular circumstances, be desired or required to take over operation/control of the vehicle and drive the vehicle so as to avoid potential hazard for as long as the autonomous system relinquishes such control or driving. Such an occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

The vehicle may include any type of sensor or sensors, such as imaging sensors or radar sensors or lidar sensors or ultrasonic sensors or the like. For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042;

US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206;

US-2014-0049646; US-2014-0052340; US-2014-0025240; US-2014-0028852; US-2014-005907; US-2013-0314503; US-2013-0298866; US-2013-0222593; US-2013-0300869;

US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587, 186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The ECU may be operable to process data for at least one driving assist system of the vehicle. For example, the ECU may be operable to process data (such as image data captured by a forward-viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle).

Optionally, the ECU may process captured data for an autonomous control system of the vehicle that controls steering and/or braking and/or accelerating of the vehicle as the vehicle travels along the road.

The system may utilize aspects of the parking assist systems described in U.S. Pat. No. 8,874,317 and/or U.S. Publication Nos. US-2017-0329346; US-2017-0317748;

US-2017-0253237; US-2017-0050672; US-2017-0017848; US-2017-0015312 and/or US-2015-0344028, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular parking assist system, the vehicular parking assist system comprising:
an ultrasonic sensor disposed at a vehicle equipped with the vehicular parking assist system, wherein the ultrasonic sensor senses exterior of the vehicle, and wherein the ultrasonic sensor is operable to capture sensor data;
a sideward viewing camera disposed at the vehicle, wherein the sideward viewing camera views a region exterior of the vehicle and at least partially along a side of the vehicle, and wherein the sideward viewing camera is operable to capture image data;
an electronic control unit (ECU);
wherein sensor data captured by the ultrasonic sensor is transferred to the ECU, and wherein image data captured by the sideward viewing camera is transferred to the ECU;
wherein the ECU comprises electronic circuitry and associated software, and wherein the electronic circuitry of the ECU comprises at least one data processor that is (i) operable to process sensor data captured by the ultrasonic sensor and transferred to the ECU and (ii) operable to process image data captured by the sideward viewing camera and transferred to the ECU;
wherein, during a parking maneuver of the vehicle, and when image data captured by the sideward viewing camera is compromised, at least in part via processing sensor data captured by the ultrasonic sensor and transferred to the ECU, and without processing image data captured by the sideward viewing camera, the vehicular parking assist system determines presence of an object based on detection of an edge of the object, and wherein the vehicular parking assist system determines presence of an available parking space based at least in part on the determined object;
wherein, during the parking maneuver of the vehicle, the vehicular parking assist system at least partially controls operation of the vehicle as the vehicle (i) is moved relative to the determined object and (ii) is moved at least partially into the determined available parking space; and
wherein, during the parking maneuver of the vehicle, and as the vehicle is moved into the determined available parking space, and at least in part via processing sensor data captured by the ultrasonic sensor and transferred to the ECU, the vehicular parking assist system tracks position of the determined object relative to the vehicle and adjusts control of the vehicle to avoid contact between the vehicle and the determined object.

2. The vehicular parking assist system of claim 1, wherein the ultrasonic sensor comprises a plurality of ultrasonic sensors disposed at the vehicle and sensing exterior of the vehicle, and wherein individual ultrasonic sensors of the plurality of ultrasonic sensors are spaced from one another at the vehicle.

3. The vehicular parking assist system of claim 2, wherein the vehicular parking assist system detects the edge of the object at least in part via processing sensor data captured by (i) a front driver-side ultrasonic sensor of the plurality of ultrasonic sensors, (ii) a front passenger-side ultrasonic sensor of the plurality of ultrasonic sensors, (iii) a rear driver-side ultrasonic sensor of the plurality of ultrasonic sensors and (iv) a rear passenger-side ultrasonic sensor of the plurality of ultrasonic sensors.

4. The vehicular parking assist system of claim 3, wherein the determined available parking space comprises a perpendicular parking space, and wherein during a nose-in parking maneuver the vehicular parking assist system tracks position of the determined object and adjusts control of the vehicle during movement into the perpendicular parking space at least in part via processing sensor data captured by the front driver-side ultrasonic sensor and the front passenger-side ultrasonic sensor.

5. The vehicular parking assist system of claim 3, wherein the determined available parking space comprises a perpendicular parking space, and wherein during a rear-in parking maneuver the vehicular parking assist system tracks position of the determined object and adjusts control of the vehicle during movement into the perpendicular parking space at least in part via processing sensor data captured by the rear driver-side ultrasonic sensor and the rear passenger-side ultrasonic sensor.

6. The vehicular parking assist system of claim 3, wherein the determined available parking space comprises a parallel parking space, and wherein during the parking maneuver the vehicular parking assist system tracks position of the determined object and adjusts control of the vehicle during movement into the parallel parking space at least in part via processing sensor data captured by the rear driver-side ultrasonic sensor and the rear passenger-side ultrasonic sensor.

7. The vehicular parking assist system of claim 3, wherein the determined available parking space comprises an angled parking space, and wherein during a nose-in parking maneuver the vehicular parking assist system tracks position of the determined object and adjusts control of the vehicle during movement into the angled parking space at least in part via processing sensor data captured by the front driver-side ultrasonic sensor and the front passenger-side ultrasonic sensor.

8. The vehicular parking assist system of claim 3, wherein the determined available parking space comprises an angled parking space, and wherein during a rear-in parking maneuver the vehicular parking assist system tracks position of the determined object and adjusts control of the vehicle during movement into the angled parking space at least in part via processing sensor data captured by the rear driver-side ultrasonic sensor and the rear passenger-side ultrasonic sensor.

9. The vehicular parking assist system of claim 1, wherein the vehicular parking assist system determines presence of the available parking space further based on processing at the ECU of vehicle kinematic data.

10. The vehicular parking assist system of claim 1, wherein the vehicular parking assist system detects the edge of the object based on points clustering of the sensor data captured by the ultrasonic sensor.

11. The vehicular parking assist system of claim 1, wherein during the parking maneuver of the vehicle, and as the vehicle is moved at least partially into the determined available parking space, and at least in part via processing sensor data captured by the ultrasonic sensor and transferred to the ECU, the vehicular parking assist system determines presence of another object at a path of travel of the vehicle.

12. The vehicular parking assist system of claim 1, wherein the determined object comprises one selected from the group consisting of (i) another vehicle and (ii) a curb.

13. The vehicular parking assist system of claim 1, wherein the vehicular parking assist system determines presence of the available parking space based on determination, at least in part via processing sensor data captured by the ultrasonic sensor and transferred to the ECU, of a vacant space spanning at least a threshold distance from the detected edge of the determined object.

14. The vehicular parking assist system of claim 13, wherein the vacant space extends between the detected edge of the determined object and a detected edge of another object.

15. The vehicular parking assist system of claim 1, wherein the vehicular parking assist system initiates the parking maneuver in response to a user input.

16. The vehicular parking assist system of claim 1, wherein the vehicular parking assist system initiates the parking maneuver in response to determination that the vehicle is geographically located in a parking lot.

17. A vehicular parking assist system, the vehicular parking assist system comprising:
a plurality of ultrasonic sensors disposed at a vehicle equipped with the vehicular parking assist system, wherein individual ultrasonic sensors of the plurality of ultrasonic sensors are spaced from one another at the vehicle, and wherein the individual ultrasonic sensors of the plurality of ultrasonic sensors sense exterior of the vehicle, and wherein the individual ultrasonic sensors of the plurality of ultrasonic sensors are operable to capture sensor data;
a sideward viewing camera disposed at the vehicle, wherein the sideward viewing camera views a region exterior of the vehicle and at least partially along a side of the vehicle, and wherein the sideward viewing camera is operable to capture image data;
an electronic control unit (ECU);
wherein sensor data captured by the plurality of ultrasonic sensors is transferred to the ECU, and wherein image data captured by the sideward viewing camera is transferred to the ECU;
wherein the ECU comprises electronic circuitry and associated software, and wherein the electronic circuitry of the ECU comprises at least one data processor that is (i) operable to process sensor data captured by the plurality of ultrasonic sensors and transferred to the ECU and (ii) operable to process image data captured by the sideward viewing camera and transferred to the ECU;
wherein, during a parking maneuver of the vehicle, and when image data captured by the sideward viewing camera is compromised, at least in part via processing sensor data captured by the plurality of ultrasonic sensors and transferred to the ECU, and without processing image data captured by the sideward viewing camera, the vehicular parking assist system determines presence of an object based on detection of an edge of the object, and wherein the vehicular parking assist system determines presence of an available parking space based at least in part on the determined object;
wherein the vehicular parking assist system detects the edge of the object at least in part via processing sensor data captured by (i) a front driver-side ultrasonic sensor of the plurality of ultrasonic sensors, (ii) a front passenger-side ultrasonic sensor of the plurality of ultrasonic sensors, (iii) a rear driver-side ultrasonic sensor of the plurality of ultrasonic sensors and (iv) a rear passenger-side ultrasonic sensor of the plurality of ultrasonic sensors;
wherein, during the parking maneuver of the vehicle, the vehicular parking assist system at least partially controls operation of the vehicle as the vehicle (i) is moved relative to the determined object and (ii) is moved at least partially into the determined available parking space;
wherein, during the parking maneuver of the vehicle, and as the vehicle is moved into the determined available parking space, and at least in part via processing sensor data captured by the plurality of ultrasonic sensors and transferred to the ECU, the vehicular parking assist system tracks position of the determined object relative to the vehicle and adjusts control of the vehicle to avoid contact between the vehicle and the determined object;
wherein the determined available parking space comprises a perpendicular parking space or an angled parking space, and wherein during a nose-in parking maneuver the vehicular parking assist system tracks position of the determined object and adjusts control of the vehicle during movement into the perpendicular parking space or the angled parking space at least in part via processing sensor data captured by the front driver-side ultrasonic sensor and the front passenger-side ultrasonic sensor; and
wherein during a rear-in parking maneuver the vehicular parking assist system tracks position of the determined object and adjusts control of the vehicle during movement into the perpendicular parking space or the angled parking space at least in part via processing sensor data captured by the rear driver-side ultrasonic sensor and the rear passenger-side ultrasonic sensor.

18. The vehicular parking assist system of claim 17, wherein the vehicular parking assist system detects the edge of the object based on points clustering of the sensor data captured by the plurality of ultrasonic sensors.

19. A vehicular parking assist system, the vehicular parking assist system comprising:
a plurality of ultrasonic sensors disposed at a vehicle equipped with the vehicular parking assist system, wherein individual ultrasonic sensors of the plurality of ultrasonic sensors are spaced from one another at the vehicle, and wherein the individual ultrasonic sensors of the plurality of ultrasonic sensors sense exterior of the vehicle, and wherein the individual ultrasonic sensors of the plurality of ultrasonic sensors are operable to capture sensor data;
a sideward viewing camera disposed at the vehicle, wherein the sideward viewing camera views a region exterior of the vehicle and at least partially along a side of the vehicle, and wherein the sideward viewing camera is operable to capture image data;
an electronic control unit (ECU);
wherein sensor data captured by the plurality of ultrasonic sensors is transferred to the ECU, and wherein image data captured by the sideward viewing camera is transferred to the ECU;
wherein the ECU comprises electronic circuitry and associated software, and wherein the electronic circuitry of the ECU comprises at least one data processor that is (i) operable to process sensor data captured by the plurality of ultrasonic sensors and transferred to the ECU and (ii) operable to process image data captured by the sideward viewing camera and transferred to the ECU;
wherein, during a parking maneuver of the vehicle, and when image data captured by the sideward viewing camera is compromised, at least in part via processing sensor data captured by the plurality of ultrasonic sensors and transferred to the ECU, and without processing image data captured by the sideward viewing camera, the vehicular parking assist system determines presence of an object based on detection of an edge of the object, and wherein the vehicular parking assist system determines presence of an available parking space based at least in part on the determined object;
wherein the vehicular parking assist system determines presence of the available parking space based on determination, at least in part via processing sensor data captured by the plurality of ultrasonic sensors and transferred to the ECU, of a vacant space spanning at least a threshold distance from the detected edge of the determined object;
wherein the vehicular parking assist system detects the edge of the object at least in part via processing sensor data captured by (i) a front driver-side ultrasonic sensor of the plurality of ultrasonic sensors, (ii) a front passenger-side ultrasonic sensor of the plurality of ultrasonic sensors, (iii) a rear driver-side ultrasonic sensor of the plurality of ultrasonic sensors and (iv) a rear passenger-side ultrasonic sensor of the plurality of ultrasonic sensors;
wherein, during the parking maneuver of the vehicle, the vehicular parking assist system at least partially controls operation of the vehicle as the vehicle (i) is moved relative to the determined object and (ii) is moved at least partially into the determined available parking space;
wherein, during the parking maneuver of the vehicle, and as the vehicle is moved into the determined available parking space, and at least in part via processing sensor data captured by the plurality of ultrasonic sensors and transferred to the ECU, the vehicular parking assist system tracks position of the determined object relative to the vehicle and adjusts control of the vehicle to avoid contact between the vehicle and the determined object; and
wherein the determined available parking space comprises a parallel parking space, and wherein during the parking maneuver the vehicular parking assist system tracks position of the determined object and adjusts control of the vehicle during movement into the parallel parking space at least in part via processing sensor data captured by the rear driver-side ultrasonic sensor and the rear passenger-side ultrasonic sensor.

20. The vehicular parking assist system of claim 19, wherein the vehicular parking assist system detects the edge of the object based on points clustering of the sensor data captured by the plurality of ultrasonic sensors.
